(19) United States
(12) Patent Application Publication
(10) Pub. No.: US 2011/0181616 A1
(43) Pub. Date: Jul. 28, 2011

(54) GRAPHICAL EFFECTS FOR AN ELECTRONIC PRINT MEDIA VIEWER

(76) Inventors: Craig Peter Sayers, Menlo Park, CA (US); Prakash Reddy, Fremont, CA (US)

(21) Appl. No.: 12/693,769

(22) Filed: Jan. 26, 2010

(51) Int. Cl. G09G 5/00

(52) U.S. Cl. 345/619

(57) ABSTRACT

Example embodiments disclosed herein relate to a computing device including a processor and a storage medium including instructions for displaying adjacent pages of an electronic print medium. The adjacent pages may include a first page belonging to a first group of pages and a second page opposite the first page belonging to a second group of pages. The storage medium may also include instructions for displaying at least one graphical effect for each page, with the graphical effect determined based on a depth of pages in the corresponding group. Example methods and machine-readable storage media are also disclosed.

### BACKGROUND

With the development of high-speed network connections, massive storage media, and intelligent user interfaces, it is now easier than ever for a user to access electronic information. In many of the world's most developed countries, computer ownership and Internet accessibility exceed seventy-five percent of the population. In addition, in recent years, capabilities of portable computers and mobile phones have dramatically expanded, allowing users to instantly access any of the billions of locations on the World Wide Web.

As the ease of access of information has increased, the expectations of users have also increased. In general, a typical user expects instant access to content including audio, video, and even content that was formerly available only in printed form, such as books and newspapers.

With these issues in mind, a number of companies, universities, and non-profit organizations have undertaken massive projects to digitize books, magazines, newspapers, and other printed media. After digitization of this media, an Internet-connected user may often access the media using any computer from any location in the world. Similarly, even new content is often released in multiple formats, including a digital format that can be obtained immediately. Users can now access the digitized media using digital book readers, mobile phones, and numerous other devices.

Despite the wide availability of electronic versions, some users still prefer to read documents in printed form. One inherent issue with digitization of information is that the quality of the user's experience in accessing that information is constrained by barriers in human-computer interaction. In particular, many interfaces for viewing electronic forms of print media, whether online or offline, are difficult to navigate, lack aesthetic appeal, and, ultimately, fail to produce a satisfying, realistic user experience.

### BRIEF DESCRIPTION OF THE DRAWINGS

In the accompanying drawings, like numerals refer to like components or blocks. The following detailed description references the drawings, wherein:

FIG. 1 is a block diagram of an embodiment of a computing device including a machine-readable storage medium encoded with instructions for displaying an electronic print medium;

FIG. 2 is a block diagram of an embodiment of a computing device and an example of an interaction with a user for receiving, displaying, and updating display of an electronic print medium;

FIG. 3 is a diagram of an embodiment of a user interface for displaying an electronic print medium;

FIG. 4A is a diagram of an example electronic print medium displayed in a closed position;

FIG. 4B is a diagram of an example electronic print medium displayed in an open position;

FIG. 5A is a diagram of an upper section of a first example electronic print medium open to an adjacent pair of pages in a first portion of the medium;

FIG. 5B is a diagram of an upper section of a first example electronic print medium open to an adjacent pair of pages in a second portion of the medium;

FIG. 5C is a diagram of an upper section of a second example electronic print medium open to an adjacent pair of pages in a first portion of the medium;

FIG. 5D is a diagram of an upper section of a second example electronic print medium open to an adjacent pair of pages in a second portion of the medium;

FIG. 6A is a diagram of a bottom section of an example electronic print medium open to an adjacent pair of pages in a first portion of the medium;

FIG. 6B is a diagram of a bottom section of an example electronic print medium open to an adjacent pair of pages in a second portion of the medium;

FIG. 7 is a flowchart of an embodiment of a method for displaying an electronic print medium in a user interface; and

FIGS. 8A and 88 are flowcharts of an embodiment of a method for displaying an electronic print medium in a user interface.

### DETAILED DESCRIPTION

As described above, many interfaces for viewing electronic forms of print media are difficult to use and provide an unsatisfying quality of experience for the user. Accordingly, various example embodiments described in detail herein relate to a user interface including graphical features that increase realism, simplify navigation, and provide a better user experience.

In particular, various example embodiments disclosed herein relate to a user interface that includes graphical effects determined based on a depth of pages in a current group of pages. In this manner, the graphical effects provide the user with a visual indication of his or her current position in the print medium. In addition, some embodiments relate to mechanisms for displaying the print medium and effects in an efficient manner that minimizes bandwidth usage and load times. Additional embodiments and applications will be apparent to those of skill in the art upon reading and understanding the following description.

In the description that follows, reference is made to the term, “machine-readable storage medium.” As used herein, the term “machine-readable storage medium” refers to any electronic, magnetic, optical, or other physical storage device that stores executable instructions or other data (e.g., a hard disk drive, random access memory, flash memory, etc.).

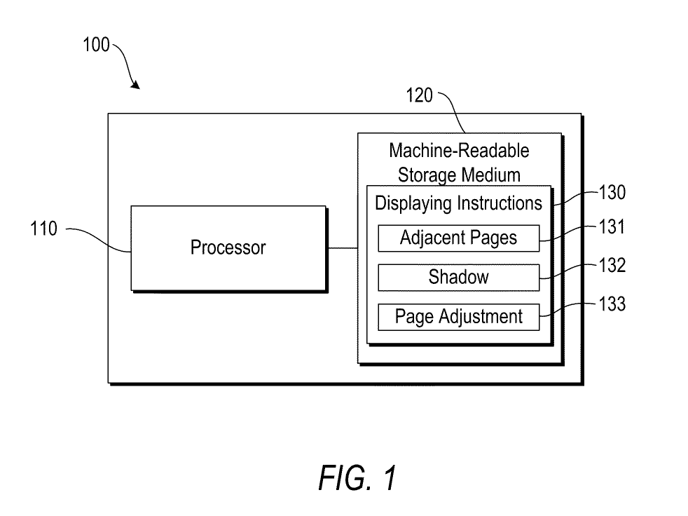

Referring now to the drawings, FIG. 1 is a block diagram of an embodiment of a computing device 100 including a machine-readable storage medium 120 encoded with instructions for displaying an electronic print medium. Computing device 100 may be, for example, a desktop computer, a laptop computer, a handheld computing device, a mobile phone, a portable reading device, or the like. In the embodiment of FIG. 1, computing device 100 includes processor 110 and machine-readable storage medium 120.

Processor 110 may be a central processing unit (CPU), a semiconductor-based microprocessor, or any other hardware device suitable for retrieval and execution of instructions stored in machine-readable storage medium 120. In particular, processor 110 may fetch, decode, and execute displaying instructions 130 to implement the functionality described in detail below.

Machine-readable storage medium 120 may be encoded with executable instructions for displaying an electronic print medium. These executable instructions may be, for example, code that is interpreted and executed by a web browser, such as JavaScript. Alternatively, these instructions may be implemented as a standalone application that loads and displays electronic print media. As another alternative, the instructions may be implemented in firmware of a device, such as a portable reading device. Other suitable formats of the executable instructions will be apparent to those of skill in the art.

An electronic print medium may include any text, images, or combination thereof for which display on computing device 100 is desirable. As an example, an electronic print medium may be a digital version of a book, newspaper, magazine, or the like in any suitable format. Such formats include text files, image files, portable document format (PDF) files, and other formats that will be apparent to those of skill in the art. As another example, an electronic print medium may simply be a digital document (e.g., a word processing file) for which display in a user-friendly format is desirable.

Machine-readable storage medium 120 may be encoded with displaying instructions 130, which may be executed to display pages of the electronic print medium. In particular, displaying instructions 130 may include instructions for displaying the adjacent pages 131, instructions for displaying one or more shadows 132, and instructions for adjusting the pages 133. The data for the pages to be displayed may be retrieved from machine-readable storage medium 120, from a server or other remote computer, or from some other machine-readable storage medium accessible to computing device 100.

In one embodiment, displaying instructions 130 may execute instructions for displaying adjacent pages 131, with the first page belonging to a first group of pages and the second page belonging to a second group of pages. Such an arrangement is analogous to a reader viewing a physical print medium in the open position, with two pages simultaneously visible and a stack of obscured pages beneath each of the visible pages. As with a physical print medium, the adjacent pages 131 displayed by displaying instructions 130 may be in left/right or top/bottom orientations.

Displaying instructions 130 may display adjacent pages 131 using one or more image files containing, for, example, scanned images of the pages of the print medium. As an alternative, displaying instructions 130 may display adjacent pages 131 by formatting a text file or other document into two adjacent pages. Such an embodiment may be used if, for example, a document has been scanned and converted to text using optical character recognition (OCR) or if the print medium was originally created electronically and the text and images are available.

Displaying instructions 130 may further include instructions for displaying one or more graphical effects for each of the adjacent pages. In some embodiments, these graphical effects include shadows 132 and/or page adjustments 133. Advantageously, the shadows 132 and page adjustments 133 may be based on a depth of the pages in the groups to which the current pages belong. For example, if the reader is one quarter through the electronic print medium, the shadows 132 and page adjustments 133 for the first page may be different than those generated for the second page, as the majority of the pages in the medium would be grouped with the second page. As a result, the viewer receives more accurate feedback regarding his or her position within the medium.

The depth of the pages in each group may be determined in a number of manners. As one example, depth may be determined based on a total number of pages in each of the groups, which may include the front or back cover. As another alternative, the depth may be determined as a real-world equivalent (e.g., inches or centimeters) based on known measurements of the corresponding physical print medium. Other suitable methods for determining the depth of pages will be apparent to those of skill in the art.

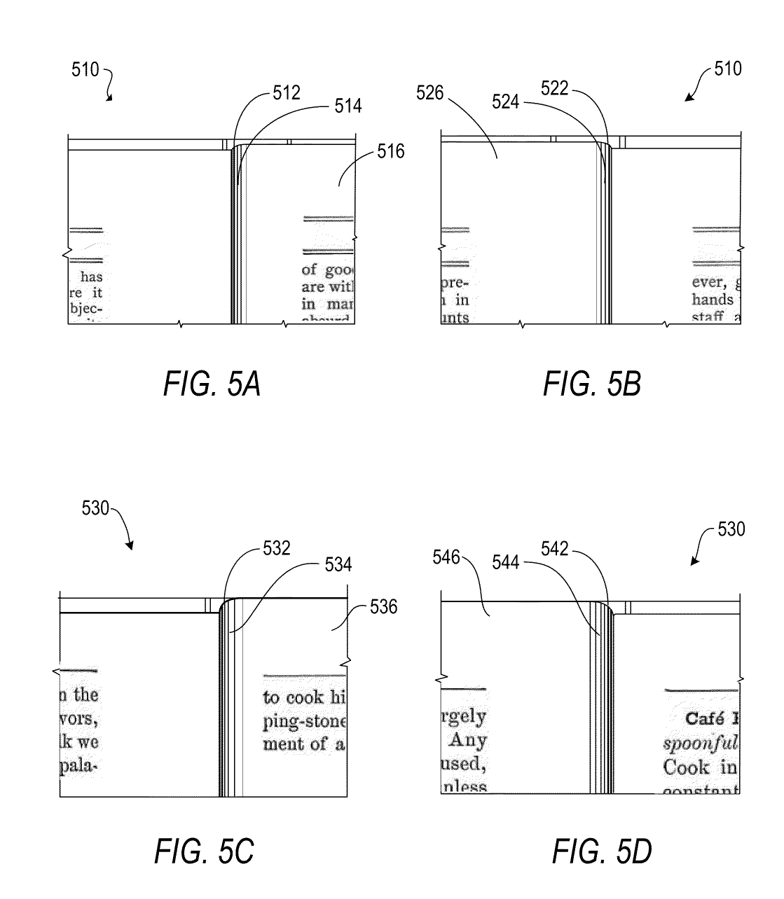

Regardless of the methodology used to determine the depth of the group of pages, the shadow 132 displayed by displaying instructions 130 may be based on the depth of pages in each group and a predetermined light source. These shadows may include, for example, a binding shadow cast on a page adjacent to a binding between the pages. The depth of the binding shadow may be determined based on a depth of pages in the corresponding group, with a greater depth generating a larger shadow. In this manner, the binding shadow may simulate the effect of a thick stack of pages casting a large shadow near the binding and a thin stack of pages casting a smaller shadow. Further examples of binding shadows are described in detail below in connection with FIGS. 5A-5D.

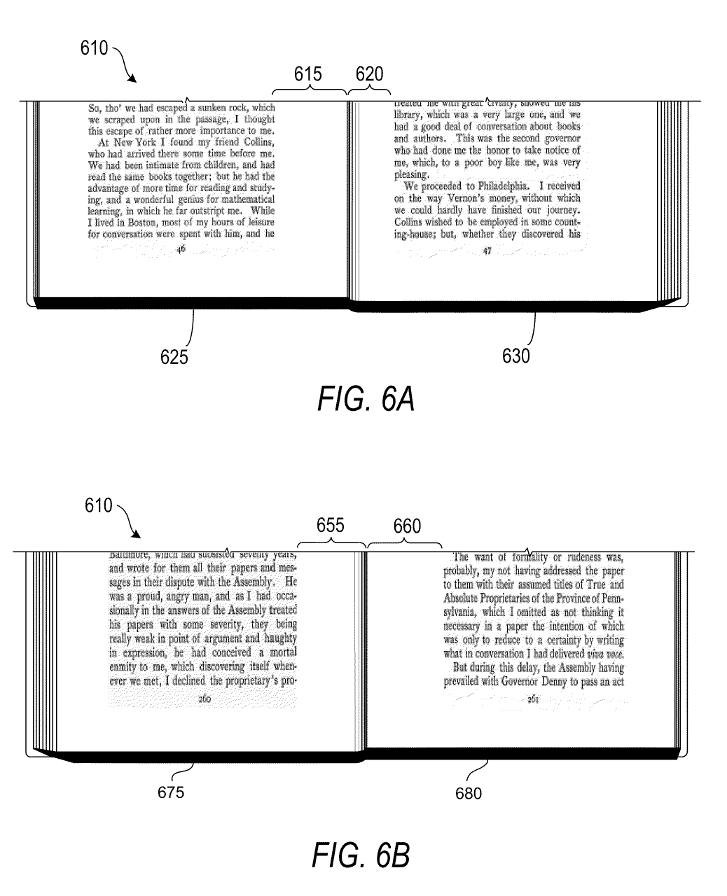

The shadows 132 may also include a shadow cast by the group of pages on an area outside of the electronic print medium. For example, if a light source is assumed to be oriented to the top-left of a print medium, the groups of pages would cast a shadow in a bottom-right direction. Again, the depth of the page shadow may be determined based on a depth of pages in the corresponding group, with a greater depth generating a larger shadow. As with the binding shadow, the page shadow may thereby simulate the effect of a thick stack of pages casting a large shadow adjacent to the print medium and a thin stack casting a smaller shadow. Further examples of page shadows are described in detail below in connection with FIGS. 6A and 6B.

In addition to shadows, displaying instructions 130 may further include instructions for displaying page adjustments 133. As with the shadows, the adjustments 133 made to each page may be based on a depth of each group of pages. The page adjustments 133 may include, for example, adjusting an amount of empty space in a top and bottom border of the corresponding page. In particular, by increasing the amount of empty space in the top and bottom borders as the depth increases (thereby increasing the size of the page), displaying instructions 130 may simulate the effect of a larger stack of pages appearing closer to the reader. Further examples of this adjustment are described in detail below in connection with FIGS. 5A-5D.

Similarly, the page adjustments 133 may also include adjusting an amount of empty space in an inside margin of the corresponding page. In particular, displaying instructions 130 may decrease the size of the inside margin as the depth of the group increases, such that the content of the page moves closer to the binding. In this manner, displaying instructions 130 may simulate the effect of the margin appearing smaller for a larger stack of pages due to the increased angle at which the page meets the binding. Further examples of this adjustment are described in detail below in connection with FIGS. 6A and 6B.

The page adjustments 133 may also include an adjustment of the degree of curvature at which each page meets the binding between the pages. In particular, the curve at which the page meets the binding may increase as the depth of the group of pages increases. Thus, for a group with little thickness, the angle at which the edges of the page meet the binding will be nearly perpendicular to the line formed by the binding. In contrast, for a group of pages with a large thickness, the angle at which the edges of the page meet the binding will increase. In this manner, displaying instructions 130 may simulate the effect of the curvature of a page meeting the binding at varying angles depending on the number of pages beneath. Further examples of this adjustment are described in detail below in connection with FIGS. 5A-5D.

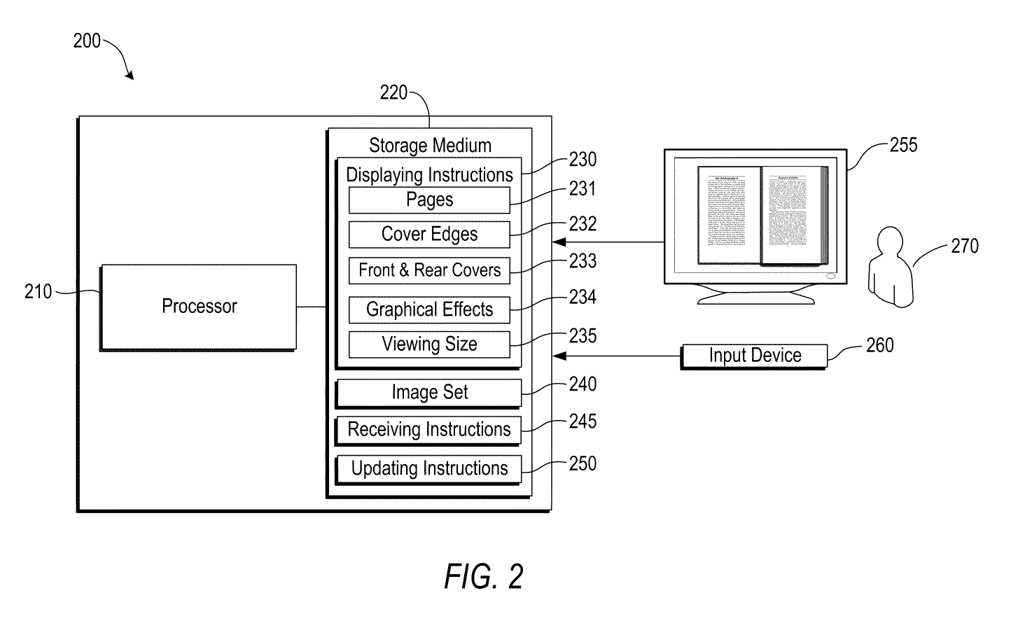

FIG. 2 is a block diagram of an embodiment of a computing device 200 and an example of an interaction with a user 270 for receiving, displaying, and updating an electronic print medium. As illustrated, computing device 200 may include processor 210, machine-readable storage medium 220, displaying instructions 230, image set 240, receiving instructions 245, and updating instructions 250.

As with processor 110, processor 210 of FIG. 2 may be a central processing unit (CPU), a semiconductor-based microprocessor, or any other hardware device suitable for retrieval and execution of instructions stored in machine-readable storage medium 220. In particular, processor 210 may fetch, decode, and execute instructions 230, 245, 250 to implement the functionality described in detail below.

Machine-readable storage medium 220 may be encoded with executable instructions for displaying pages of the electronic print medium and corresponding graphical effects. As with instructions 130, the executable instructions encoded on machine-readable storage medium 220 may be in the form of a web script, a standalone application, firmware of an electronic device, or the like. Displaying instructions 230 may be configured to display adjacent pages 231 of the electronic print medium, as described in detail above in connection with displaying instructions 130 of FIG. 1.

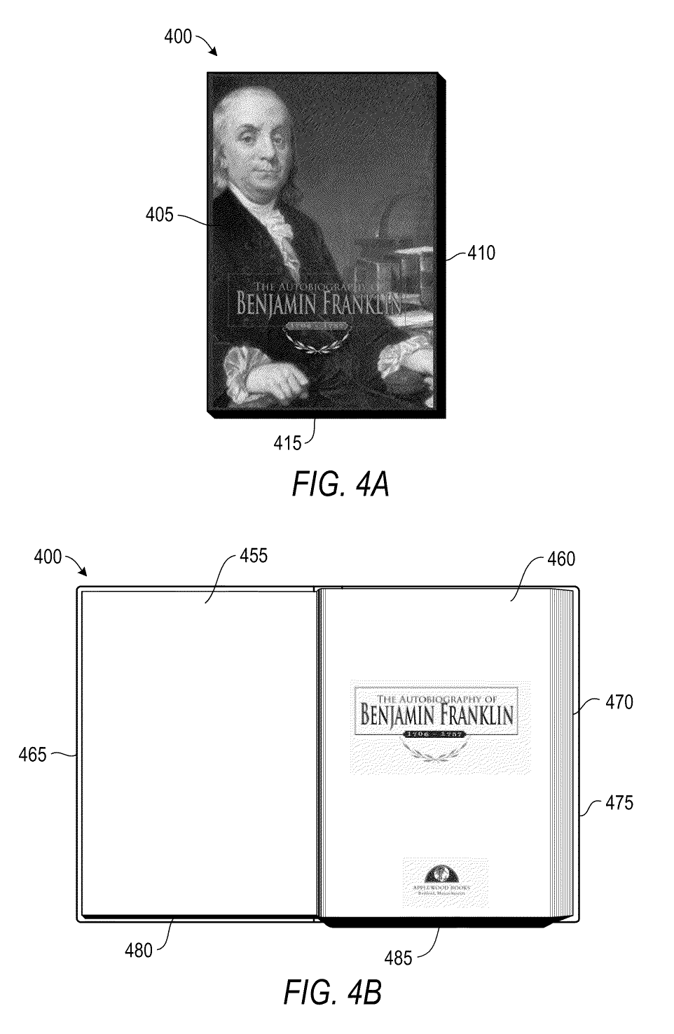

In addition, displaying instructions 230 may be further configured to display edges 232 of a cover of the electronic print medium, which may be either a hardcover or a softcover. In particular, displaying instructions 230 may display edges of the cover simultaneously with the currently-displayed pages. Depending on the particular medium and viewing angle, edges 232 may include up to four visible edges, one visible on each side of the print medium. In this manner, displaying instructions 230 may simulate the visibility of the outside edges of a cover when a print medium is in an open position. Further examples of the display of the edges 232 are described in detail below in connection with FIG. 4B.

In addition to the edges of the cover, displaying instructions 230 may be configured to display the front and rear covers 233 when the print medium is in the closed position. In some embodiments, the display of the front cover may occur automatically upon user initiation of reading of the print medium. In addition, when the print medium is in the open position, displaying instructions 230 may trigger display of either the outside or inside face of the front cover upon user selection of the outside edge 232 of the front cover. Similarly, displaying instructions 230 may trigger display of the outside or inside face of the rear cover upon selection of the outside edge of the rear cover visible beneath the currently-displayed pages. Such an implementation is advantageous, as the user may quickly flip to the front or rear of the print medium without manually navigating through the entire medium. Further examples of the display of the covers 233 are described in detail below in connection with FIG. 4A.

Displaying instructions 230 may also include instructions for displaying graphical effects 234. As described in detail above in connection with displaying instructions 130 of FIG. 1, these graphical effects may include a shadow cast by each group of pages or an adjustment of the shape of the currently-displayed pages. In addition, displaying instructions 230 may be further configured to provide graphical effects for the cover edges 232 and front/rear covers 233. In particular, graphical effects 234 may include a shadow cast by the cover edges 232, which may have a depth based, for example, on the length or width of the print medium and the thickness of the cover. In addition, graphical effects 234 may include a shadow cast by the entire print medium when in a closed position (i.e., when front or rear covers 233 are visible). In such an instance, the depth of the shadow may be determined based on a length, width, and depth of the electronic print medium. Such measurements correspond to the physical print medium or may be otherwise determined or specified prior to display of the electronic print medium.

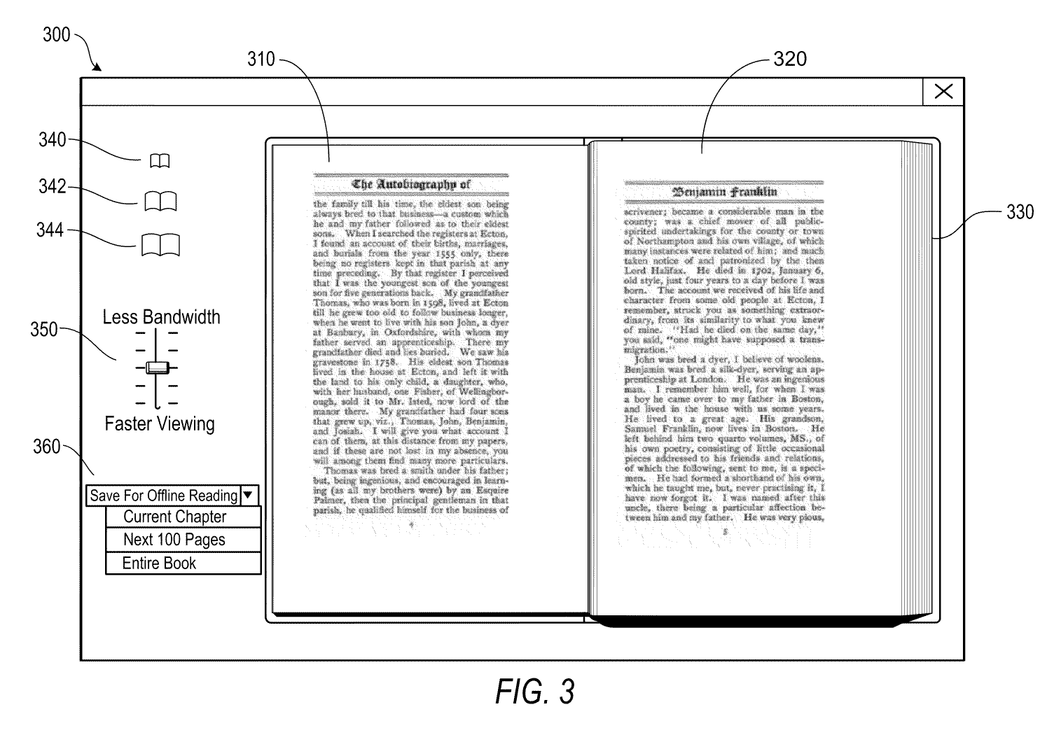

Displaying instructions 230 may also be configured to display the electronic print medium in each of a number of viewing sizes 235. As one example, the user interface displayed to user 270 may include an interface element through which the user may select a preferred size of the print medium. An example of such an interface element is described in further detail below in connection with FIG. 3. As another example, the viewing size 235 may be automatically determined based on a measurement of bandwidth available to the user, a load on a server, and/or any of a number of other factors.

Based on the currently-selected viewing size 235, displaying instructions 230 may adjust the size of pages 231, cover edges 232, front/rear covers 233, and graphical effects 234. When the print medium is stored using text, displaying instructions 230 may, for example, increase a font size of the text as the selected viewing size 235 increases. Alternatively, when the print medium is stored as a series of images, displaying instructions 230 may display images from a selected set of images, with each set of images corresponding to a particular viewing size. In some embodiments, in an effort to minimize the number of image sets while maintaining image quality, displaying instructions 230 may obtain the images of a smaller viewing size by downscaling the images of a larger viewing size.

In addition to displaying instructions 230, machine-readable storage medium 220 may also be encoded with image set 240, which may be used to display pages 231, cover edges 232, front/rear covers 233, and to determine graphical effects 234. In particular, image set 240 may comprise a plurality of images (e.g., Joint Photographic Experts Group (JPEG) files, Portable Network Graphics (PNG) files, etc.), each image corresponding to a particular page or cover of the electronic print medium.

In addition, image set 240 may include a set of images used for generation of graphical effects 234. As an example, image set 240 may include images for a binding shadow, a page shadow, a cover edge shadow, a cover shadow, page curvature used for page adjustments, and the like. In some embodiments, each image in the set may be cached on storage medium 220 or another storage medium accessible to computing device 200.

Using these images, displaying instructions 230 may generate the graphical effects by scaling, shifting, flipping, or otherwise manipulating each of the effects images based on a length or width of the print medium and the depth of pages in the particular group. For example, when displaying the shadow cast by the cover for a large print medium with a large number of pages, displaying instructions 230 may significantly stretch both the length and width of a cover shadow image in accordance with a predetermined scaling algorithm. In contrast, for a large print medium with a small number of pages, stretching of only the width may be sufficient. Displaying instructions 230 may then display the graphical effects 234 at an appropriate location in the user interface. As an example implementation, each graphical effect may be determined by scaling the height and width of the effect image as a function of one or more of the length, width, and depth of the print medium or page group. The scaled effect image may then be shifted to an appropriate set of coordinates on the user's display.

Such implementations are advantageous, as they significantly reduce the amount of data required to be stored and/or transferred, as all graphical effects may be generated using a small set of images. Furthermore, such implementations eliminate the need for creation of a three-dimensional (3D) model and the processing power required for rendering the graphical effects. It should be noted, however, that generation of the graphical effects may be performed using a rendered 3D model in environments where sufficient computing power is present.

Storage medium 220 may further comprise receiving instructions 245, which may be configured to receive and process instructions provided by user 270 through input device 260. In particular, receiving instructions 245 may be configured to receive an indication to display a new pair of adjacent pages or to display the front or rear cover of an electronic print medium. Such input may be provided through a user interface, such as interface 300 of FIG. 3, described in further detail below.

In addition, storage medium 220 may include updating instructions 250, which may be provided to update the current display based on receipt of an instruction from user 270 by receiving instructions 245. In particular, updating instructions 250 may trigger retrieval of a new pair of pages and display of corresponding effects by displaying instructions 230. As another example, updating instructions 250 may determine that the user has selected a different viewing size 235 and therefore trigger update of the viewing size by displaying instructions 230.

In some embodiments, updating instructions 250 may be configured to determine whether an update is required for each graphical effect as a condition to triggering display instructions 230 to recompute and update the graphical effect. For example, if a user turns the page to the next page in the print medium, updating instructions 250 may determine that it is unnecessary to recalculate the binding shadow or page shadow, as one page will likely make an insignificant difference in the depth of the shadows. Thus, as an example implementation, updating instructions 250 may maintain ranges of pages for which each graphical effect will remain the same and only update when a new pair of pages is outside of the current range. In this manner, updating instructions 250 may avoid unnecessary calculations and display updates, such that the speed of the interface is increased.

Output device 255 may include a display device, such as a monitor, liquid crystal display (LCD) screen, or an electronic ink display. It should be apparent, however, that any suitable display may be used, provided that the print medium and interface are displayed to user 270. Output device 255 may be internal or external to computing device 200 depending on the configuration of computing device 200.

Input device 260 may include a mouse, a keyboard, a touchpad, and/or a microphone. It should be apparent, however, that any suitable input device may be used, provided that user 270 may communicate instructions to computing device 200. Input device 260 may be internal or external to computing device 100 depending on the configuration of computing device 100.

FIG. 3 is a diagram of an embodiment of a user interface 300 for displaying an electronic print medium. Interface 300 may include a first page 310, a second page 320, a page stack 330, viewing size interface elements 340, 342, 344, prefetching interface element 350, and caching interface element 360.

As illustrated, interface 300 may display a pair of adjacent pages including a first page 310 and a second page 320. First page 310 belongs to a group including all pages on the left side of the print medium, while second page 320 belongs to a group including all pages on the right side of the print medium. In operation, a user may navigate between pages by clicking, touching, or otherwise selecting either of the pages 310, 320 in a predetermined location. In some embodiments, this predetermined location includes any position on the entire page. Upon selection of page 310, interface 300 may trigger a transition to a previous page in the print medium. Similarly, upon selection of page 320, interface 300 may trigger a transition to a subsequent page in the print medium.

As the user navigates through the print medium, page transitions may be animated. As an example, on computing devices 100, 200 with significant processing and graphics power, a smooth page transition may be achieved using computer graphics techniques by physically modeling the paper leaves and applying texture mapping, shadows, and shading to enhance the effect in a manner that accurately depicts a physical print medium.

As an alternative, page transitions may be quickly implemented using a multi-step process. For example, if the user moves from a first pair of pages at the beginning of the print medium to a second pair of pages in the middle, the interface may first update the interface to show the right hand page of the second pair and a group of pages in the middle at an angle of roughly ninety degrees to the print medium. After a predetermined period later (e.g., a fraction of a second), the interface may then render the left-hand page. Similarly, if the user moved backwards in the print medium, the user interface would first update the left page, then update the right page. Such a technique may be similarly applied to a print medium with a top/bottom orientation.

Page stack 330 may be displayed to provide a visual clue as to the depth of the print medium. As with the shadows and page adjustments, the depiction of page stack 330 may vary depending on the depth of the group of pages. As one example, the angle formed between the edges of the page stack may increase as the depth of the stack of pages 330 increases. Thus, as depicted in FIG. 3, an angle at which a right edge of stack 330 meets the top edge is greater than ninety degrees, while the angle formed by the edges of the stack on the left page is roughly ninety degrees. In some embodiments, a user may navigate to a particular page by clicking, touching, or otherwise selecting a corresponding location in page stack 330. A transition to the particular page may then be displayed, as described above.

Interface 300 may further include interface elements 340, 342, 344, each corresponding to a viewing size for the print medium. As illustrated, the smallest viewing size 340 is currently selected. In response to a change of viewing size by user activation of elements 342, 344, interface 300 may be updated to change the size of pages 310, 320 and to cause a corresponding change in the size of the cover edges and graphical effects. Such a change may be implemented by displaying instructions 230, as described in further detail above in connection with FIG. 2.

In addition, interface 300 may include prefetching interface element 350, which may be used in implementations requiring server connectivity (i.e., online versions of the electronic print media viewer). In such implementations, computing device 100, 200 obtains the pages to be displayed from a remote server. Prefetching of non-displayed pages may be implemented to download and store other pages, such that the speed of a page change may be increased.

Prefetching interface element 350 may allow the user to adjust the trade-off between bandwidth usage and viewing speed inherent in the process of prefetching. Thus, when the user moves the slider in an upward direction, computing device 100, 200 may reduce the rate at which pages are retrieved from a remote server, thereby conserving bandwidth. In contrast, when the user moves the slider in a downward direction, computing device 100, 200 may increase the rate at which pages are retrieved from the remote server, thereby increasing the likelihood of a fast page change.

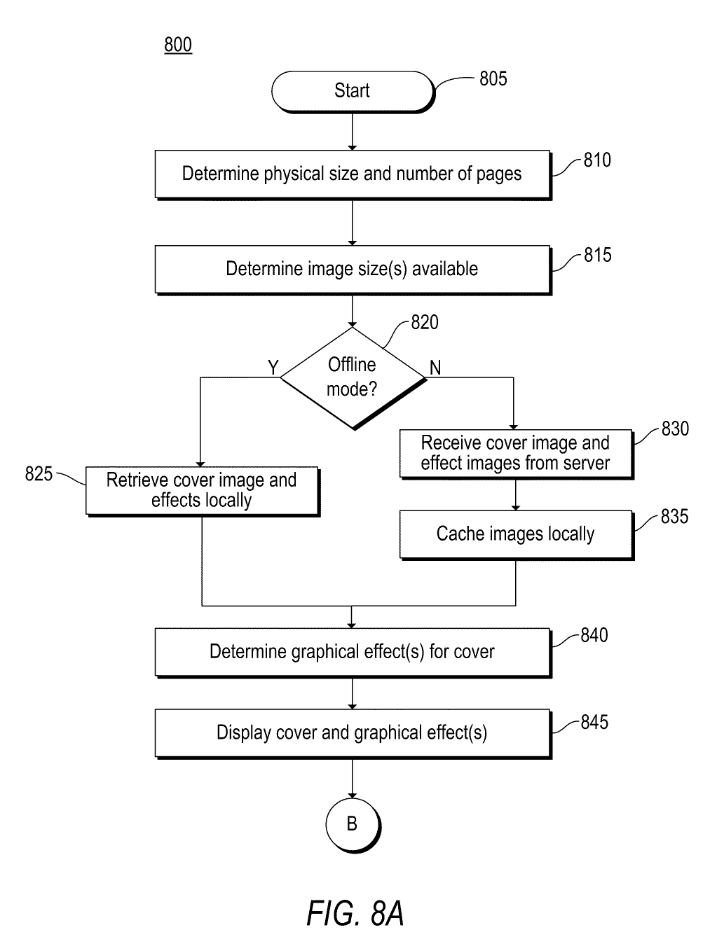

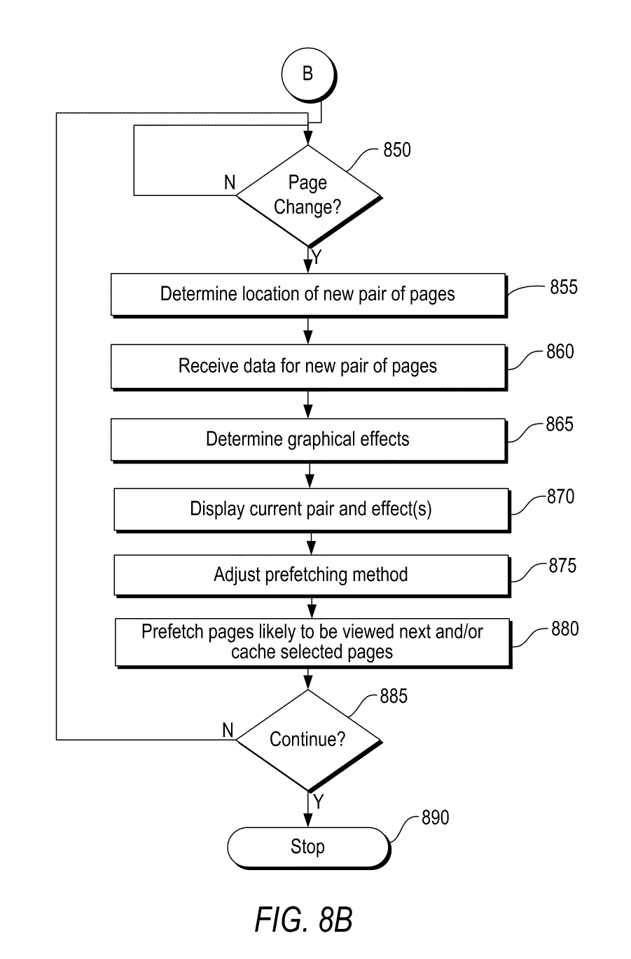

It should be apparent that interface elements other than a slider may be used for prefetching element 350. Examples of such interface elements include a list of buttons, a drop-down menu, a field for entry of a number, and the like. Furthermore, as described in detail below in connection with FIG. 8B, adjustment of prefetching may be implemented automatically without the need for user interaction with a prefetching interface element 350.

Interface 300 may also include a caching interface element 360, which may be used to manually trigger caching of a number of pages of the print medium. Again, such an interface element is useful in online implementations of the electronic print media viewer. Thus, as illustrated, interface element 360 may allow a user to cache a current chapter, the net 100 pages, or the entire print medium. In response to selection of a particular item in the drop-down menu, computing device 100, 200 may then download the corresponding portion of the print medium from the remote server. Such implementations are advantageous, as they allow a user to access the downloaded pages without the need for a connection to the server.

It should be noted that interface elements other than a drop-down menu may be used for caching interface element 360. For example, element 360 may instead be a list of buttons with a “Cache” action button. As another example, element 360 may be a box allowing for entry of a range of pages, which could be contiguous or non-contiguous. Other suitable interface elements will be apparent to those of skill in the art.

Although shown as illustrating a single book at a large size, it should be apparent that interface 300 may be designed to render one or more electronic print media at a smaller size. For example, one or more small versions of a print medium could be displayed simultaneously with a currently-viewed print medium or in a separate interface of small versions. In such instances, each small print medium could be opened to a last-viewed page, thereby serving as a visual reminder that the user was partially through one or more books.

FIG. 4A is a diagram of an example electronic print medium 400 displayed in a closed position. As illustrated, when in a closed position, print medium 400 may include front cover 405, side shadow 410, and bottom shadow 415. Front cover 405 may be, for example, a scanned image of the corresponding front cover of the physical print medium. Alternatively, if no image of the front cover is available, front cover 405 may include generated text and/or graphics identifying the print medium.

Side shadow 410 may be determined based on the depth (e.g., the number of pages, physical thickness, etc.) and the length of the print medium. Similarly, bottom shadow 415 may be determined based on the depth and width of the print medium. As described in detail above, these shadows may be generated by manipulating a shadow image or, alternatively, by rendering the shadow using a 3D model. It should be noted that, as illustrated, shadows 410 and 415 are determined based on a light source to the top left of the print medium. Suitable replacement shadows based on alternative light source positions will be apparent to those of skill in the art.

FIG. 4B is a diagram of an example electronic print medium 400 displayed in an open position. As illustrated, the open position of medium 400 may include inside face 455 of cover 405, title page 460, left cover edge 465, right cover edge 470, side shadow 475, and page shadows 480, 485. Display of inside face 455 and title page 460 may be triggered by user selection of front cover 405, while display of front cover 405 may be triggered by user selection of inside face 455.

Cover edges 465, 470 may correspond to an outer edge of the print medium and, in some embodiments, may be colored to aid in user differentiation between different print media. For example, the color of edges 465, 470 may be copied from the edge of an image used for front cover 405, may be manually specified in metadata for the electronic print medium, or may be computed from metadata of the print medium (e.g., lowest bits of a hash value of the author and title). As another alternative, the color of the edges 465, 470 may be determined on a per-user basis, such that the colors change for each print medium opened by the user (e.g., the first print medium has a green cover, the next black, the next blue, etc.). As described in detail above, user selection of the edges of the cover may trigger display of the front or rear cover. For example, selection of edge 465 may trigger display of front cover 405, while selection of edge 470 may trigger display of the inside or outside face of the rear cover.

In addition to the content of inside face 455 and title page 460, the display of print medium 455 may include a number of graphical effects. Side shadow 475 may be displayed to simulate a shadow cast by edge 470. In particular, side shadow 475 may be based on the length of electronic print medium 400 and a thickness of the cover of the print medium. Similarly, page shadows 480, 485 may be displayed to simulate the shadow cast by the stacks of pages on each side of the print medium. Thus, in this example, the depth of the pages of the group including the inside cover 455 is equivalent to the depth of the cover, while the depth of the pages of the group including title page 460 is equivalent to the depth of all pages in the print medium plus the depth of the rear cover. Suitable methods for determining and displaying shadows 475, 480, 485 are described in further detail above in connection with displaying instructions 130, 230 of FIGS. 1 and 2.

FIG. 5A is a diagram of an upper section of a first example electronic print medium 510 open to an adjacent pair of pages in a first portion of the medium. The display of print medium 510 includes page curvature 512, binding shadow 514, and top border 516. As illustrated, print medium 510 is open to a pair of pages near the beginning of the print medium.

Thus, the depth of the group of pages on the right is significantly greater than the depth of the group of pages on the left side. Accordingly, a degree of curvature of page curvature 512 may be greater for the right page than the left page. In particular, the curvature 512 represents the curvature of the page meeting the binding with a large number of pages underneath. In contrast, the left page has little or no curvature at the point where it meets the binding.

In addition, the depth of binding shadow 514 of the right page is also greater than the depth of the binding shadow for the left page. Again, the depth of shadow 514 may increase as the depth of the group of pages increases, such that the shadow simulates the effect of a page meeting the binding with a large number of pages underneath. In contrast, the binding shadow on the left page is barely visible.

Furthermore, the application of a page adjustment to the right page results in an increase in the amount of white space in top border 516. In particular, because the group of pages to which the right page belongs includes a large number of pages, the right page would appear to be closer to the user. The interface used to display print medium 510 may simulate this effect by increasing the size of the page. In some embodiments, the size of the image used for the content of the pages may remain the same, with the adjustments being applied to the borders of the page. In this manner, the perspective of a reader may be simulated without the potential for artifacts introduced by scaling the page data.

It should be noted that although illustrated for the top of the pages, curvature 512, binding shadow 514, and border 516 may be similarly adjusted on the bottom of the pages. Furthermore, such graphical effects are equally applicable to electronic print media including a top/bottom orientation, rather than a left/right orientation.

FIG. 5B is a diagram of an upper section of a first example electronic print medium 510 open to an adjacent pair of pages in a second portion of the medium. The display of print medium 510 includes page curvature 522, binding shadow 524, and top border 526. As illustrated, print medium 510 is open to a pair of pages near the end of the print medium.

Thus, the depth of the group of pages on the left is now significantly greater than the depth of the group of pages on the right. Accordingly, a degree of curvature of page curvature 522 may be greater for the left page than for the right page. In addition, the depth of binding shadow 524 may also be greater for the left page than the right page. Finally, the application of a page adjustment to the left page results in an increase in an amount of white space in top border 526.

FIG. 5C is a diagram of an upper section of a second example electronic print medium 530 open to an adjacent pair of pages in a first portion of the medium. As illustrated, electronic print medium 530 includes a greater number of pages than electronic print medium 510. Thus, the range of the degree of graphical effects for print medium 530 may be greater than the corresponding range for print medium 510.

As illustrated, the depth of the group of pages on the right of print medium 530 is significantly greater than the depth of the group of pages on the left side. Accordingly, a degree of curvature of page curvature 532 may be greater for the right page than the left page and greater than the degree of curvature 512 illustrated in FIG. 5A. In addition, the depth of binding shadow 534 may also be greater for the right page than the left page and greater than the depth of binding shadow 514. Finally, the application of a page adjustment to the right page results in an increase in the amount of white space in top border 536. As illustrated, the amount of white space in top border 536 is greater than the amount of white space in border 516 of FIG. 5A, such that the border 536 extends further beyond the left page, nearly obscuring the cover edge.

FIG. 5D is a diagram of an upper section of a second example electronic print medium 530 open to an adjacent pair of pages in a second portion of the medium. The display of print medium 530 includes page curvature 542, binding shadow 544, and top border 546. As illustrated, print medium 530 is open to a pair of pages near the end of the print medium.

Thus, the depth of the group of pages on the left is now significantly greater than the depth of the group of pages on the right. Accordingly, a degree of curvature of page curvature 542 may be greater for the left page than for the right page. In addition, the depth of binding shadow 544 may be greater for the left page than the right page. Finally, the application of a page adjustment to the left page results in an increase in an amount of white space in top border 546.

FIG. 6A is a diagram of a bottom section of an example electronic print medium 610 open to an adjacent pair of pages in a first portion of the medium. The display of print medium 610 includes inside margins 615, 620 and page shadows 625, 630. As illustrated, print medium 610 is open to a pair of pages near the beginning of the print medium.

Thus, the depth of the group of pages on the right is significantly greater than the depth of the group of pages on the left side. Accordingly, a width of inside margin 620 of the right page may be less than a corresponding width of inside margin 615 of the left page. In this manner, the sizing of the right inside margin 620 may simulate the appearance of a smaller margin when a displayed page is on top of a large group of pages, as the angle at which the page meets the binding is increased. Conversely, the sizing of the left inside margin 615 may simulate the appearance of a larger margin when a displayed page is on top of a smaller group of pages, as the angle at which the page meets the binding will be nearly horizontal.

The depth of page shadows 625, 630 may also be determined based on a depth of the group of pages on each side. Thus, because the left group includes a smaller number of pages, a page shadow 625 cast below the left side of print medium 610 will have a relatively small depth. In contrast, because the right group includes a relatively large number of pages, a page shadow 630 cast below the right side of print medium 610 will have a larger depth. Again, such an effect provides the reader with a better sense of the thickness of the print medium and his or her position within the print medium.

It should be noted that although illustrated for the bottom of the pages, inside margins 615, 620 and page shadows 625, 630 may be similarly adjusted on the top of the pages, depending on the location of the light source. Furthermore, such graphical effects are equally applicable to electronic print media including a top/bottom orientation, rather than a left/right orientation.

FIG. 6B is a diagram of a bottom section of an example electronic print medium 610 open to an adjacent pair of pages in a second portion of the medium. As illustrated, print medium 610 is now open to a pair of pages near the end of the print medium.

As a result, the number of pages in the left group of pages is now significantly greater than the number of pages in the right group. Accordingly, inside margin 655 may be adjusted to be smaller than inside margin 615 of FIG. 6A. Conversely, inside margin 660 may be adjusted to be larger than inside margin 620. In addition, page shadow 675 may be adjusted to be greater in depth than page shadow 625, while page shadow 680 may be adjusted to be smaller in depth than page shadow 630.

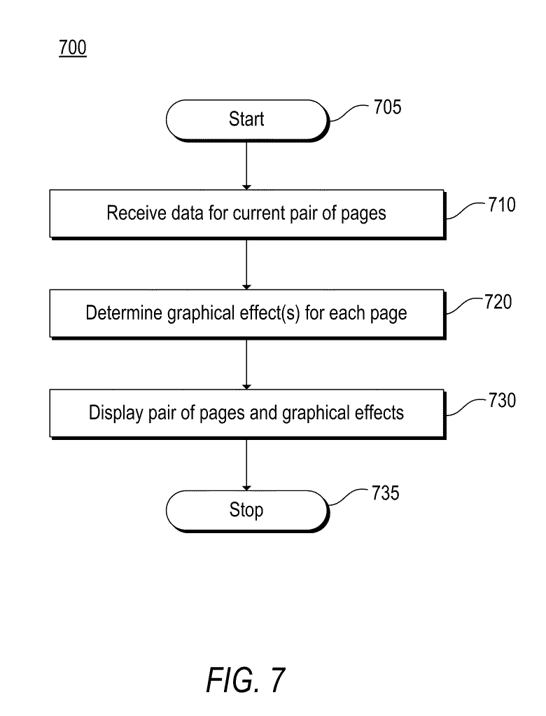

FIG. 7 is a flowchart of an embodiment of a method 700 for displaying an electronic print medium in a user interface. Although execution of method 700 is described below with reference to the components of computing device 100, other suitable components for execution of method 700 will be apparent to those of skill in the art. Method 700 may be implemented in the form of executable instructions stored on a machine-readable storage medium, such as machine-readable storage medium 120 of FIG. 1.

Method 700 may start in block 705 and proceed to block 710, where computing device 100 may receive data for a current pair of adjacent pages of an electronic print medium. Each of these pages may belong to a corresponding group of pages including one or more pages each. Computing device 100 may retrieve the data for the pages from machine-readable storage medium 120, from a server or other remote computer, or from another machine-readable storage medium accessible to computing device 100. The pages may be text files, image files, PDF files, or files in other formats that will be apparent to those of skill in the art.

After receipt of the data for the pages, method 700 may then proceed to block 720, where computing device 100 may determine a graphical effect for each page in the pair. These graphical effects may include a shadow cast by each group of pages and/or a shape adjustment for the displayed pages. In some embodiments, the graphical effects may be determined based on a depth of pages in each group. The graphical effects may include, for example, a shadow cast on the binding of the print medium, a shadow cast by a group of pages on an area outside of the electronic print medium, and a degree of curvature and margin/border width of the pages. Other suitable shadows and page adjustments will be apparent to those of skill in the art.

Method 700 may then proceed to block 730, where computing device 100 may display the pair of adjacent pages using the received data and display the one or more graphical effects determined for each page of the pair of adjacent pages. In some embodiments, a number of graphical effects may be displayed first, the pages may be displayed second, and the remaining graphical effects may be displayed last. In other embodiments, the pages and graphical effects are displayed substantially simultaneously. Other suitable arrangements for displaying the pages and effects will be apparent to those of skill in the art. After displaying the pages and graphical effects, method 700 may then proceed to block 735, where method 700 stops.

FIGS. 8A and 8B are flowcharts of an embodiment of a method 800 for displaying an electronic print medium in a user interface. Although execution of method 800 is described below with reference to the components of computing device 200, other suitable components for execution of method 800 will be apparent to those of skill in the art. Method 800 may be implemented in the form of executable instructions stored on a machine-readable storage medium, such as machine-readable storage medium 220 of FIG. 2.

Method 800 may start in block 805 and proceed to block 810, where computing device 200 may determine the physical size of the print medium and determine a total number of pages included in the medium. Computing device 200 may make this determination by, for example, receiving data from a remote server or retrieving a local record. The physical size of the print medium may represent, for example, real-world dimensions of an actual print medium or another measurement representative of size (e.g., a number of pixels, ratio between dimensions, etc.).

Method 800 may then proceed to block 815, where computing device 200 may determine the image sizes available for display of the electronic print medium. Again, such a determination may be made by, for example, receiving data from a remote server or retrieving a local record. The determination of the number of image sizes may then be used in displaying viewing size interface elements 340, 342, 344 of the user interface.

Method 800 then proceeds to decision block 820, where computing device 200 determines whether the electronic print media viewer should be executed in an offline mode. Computing device 200 may determine which mode to use based on, for example, the presence of an active Internet connection. Alternatively, the print media viewer may be natively configured to run in either online or offline mode. As another alternative, computing device 200 may decide based on the local availability of the electronic print medium to be displayed.

When it is determined in decision block 820 that the media viewer should run in an offline mode, method 800 proceeds to block 825, where computing device 200 locally retrieves the image of the cover and any images used for generation of graphical effects. Alternatively, when it is determined in decision block 820 that the media viewer will run in an online mode, method 800 proceeds to block 830, where computing device 200 retrieves the image of the cover and any images used for generation of graphical effects from a remote server, which may be, for example, a web server. Computing device 200 may then locally cache the received cover image and any graphical effects images.

After block 825 or block 835, method 800 proceeds to block 840, where computing device 200 determines one or more graphical effects for the print medium in the closed position. As described in detail above, the effects may include a bottom and side shadow. The depth of any shadows may be determined based on the length, width, and depth of the electronic print medium. Method 800 may then proceed to block 845, where computing device 200 may display the cover and any graphical effects to the user.

It should be noted that, although execution of method 800 assumes that the print media viewer will start at the front cover, other starting points in the book are possible. For example, if the viewer were implemented as a web page, then the current page number could be encoded as a fragment identifier and then transmitted, stored, and retrieved as part of the webpage URL using standard web browser history and bookmarking functions. Other suitable arrangements for recalling the user's position within the book and resuming that position in a subsequent session will be apparent to those of skill in the art.

After displaying the cover or other starting page to the user, method 800 may then proceed to block 850, where computing device 200 may continuously monitor for a page change by the user. When a page change occurs, method 800 may proceed to block 855, where computing device 200 determines the location of the new pair of pages in the print medium. For example, when the user clicks the front cover of the print medium, computing device 200 may increment the page by one, such that the inside cover and title page constitute the new pair. As another example, if the user clicks on the left or right side of an open page, computing device 200 may decrement or increment the current pair, respectively.

After determining the new pair of pages, method 800 may proceed to block 860, where computing device receives data for the new pair of pages. Again, computing device 200 may locally retrieve the data when in an offline mode or retrieve the data from a remote server when in an online mode. In addition, if data for the pages has been cached, computing device 200 may locally retrieve the data, even when in an online mode.

Method 800 may then proceed to block 865, where computing device 200 determines effects for the new pair of pages. In particular, computing device 200 may calculate a shadow and/or a shape adjustment for each of the pages based on a number of pages in a respective group to which each page belongs. In some embodiments, computing device 200 may determine the appropriate effects by scaling, shifting, flipping, or otherwise manipulating a graphical effects image retrieved in step 825 or 830. Method 800 may then proceed to block 870, where computing device 200 displays the current pair of pages and any determined graphical effects to the user.

After display of the current pair of pages, method 800 may proceed to block 875, where computing device 200 may adjust a prefetching method. As one example, computing device 200 may determine a number of pages to prefetch based on a measurement of bandwidth currently available to the user or based on a measurement of a current load of the remote server. The bandwidth available to the user could be determined, for example, by periodically downloading a file of predetermined size and measuring an amount of time to receive the whole file. Similarly, the current load of the remote server could be determined by measuring a number of bytes transmitted in a predetermined period, by monitoring memory or processor usage, or by performing similar measurements. Other suitable methods for determining available bandwidth and server load will be apparent to those of skill in the art.

Alternatively, computing device 200 may determine a number of pages to prefetch based on a current setting of a prefetching interface element 350. In particular, computing device 200 may decrease a number of pages to prefetch as the user indicates a preference for less bandwidth usage. Conversely, computing device 200 may increase a number of pages to prefetch as the user indicates a preference for faster page switching.

After making any adjustments to the prefetching method, method 800 may then proceed to block 880, where computing device 200 may prefetch the determined number of pages. In some embodiments, the specific pages to be prefetched may be determined by predicting the pages most likely to be viewed next by the user. As an example, computing device 200 may preferentially download the next left-hand page, then the right page of the next pair, then the first pages of chapters, and proceed similarly until all pages are downloaded.

In addition to prefetching pages likely to be viewed next, computing device 200 may also download and cache any pages requested by the user. For example, a user may indicate that a group of pages should be saved for offline reading using caching element 360.

Method 800 may then proceed to block 885, where computing device 200 may determine whether execution of the print media viewer should continue. In some embodiments, execution may continue until the user closes the program, shuts down the device, or otherwise manually halts execution.

When it is determined that execution should continue, method 800 may return to block 850, where computing device 200 may monitor for a page change, while continuing to prefetch and cache. Alternatively, when it is determined that execution should not continue, method 800 may proceed to block 890, where method 800 stops.

According to the embodiments described in detail above, an electronic print media viewer may include graphical effects that are displayed to increase realism, simplify navigation, and provide a better user experience. In particular, the graphical effects may include a shadow and/or a page adjustment that provide the user with an accurate indication of his or her position within the print medium, while also increasing the aesthetic appeal of the interface. Such features increase user satisfaction and therefore increase the likelihood of continued use of the viewer.

We claim:

1. A computing device comprising:
a processor; and
a machine-readable storage medium encoded with instructions executable by the processor, the machine-readable storage medium comprising:
instructions for displaying adjacent pages of an electronic print medium, the adjacent pages including a first page belonging to a first group of pages and a second page opposite the first page belonging to a second group of pages, and
instructions for displaying at least one graphical effect corresponding to the first page and at least one graphical effect corresponding to the second page, wherein:
each of the at least one graphical effects comprises a shadow cast by the corresponding group of pages or an adjustment of a shape of the corresponding page,
the at least one graphical effect corresponding to the first page is determined based on a depth of pages in the first group, and
the at least one graphical effect corresponding to the second page is determined based on a depth of pages in the second group.

2. The computing device of claim 1, wherein the machine-readable storage medium further comprises:
instructions for displaying edges of a cover of the electronic print medium simultaneously with the first and second pages, the cover including an outside edge of a front cover and an outside edge of a rear cover,
instructions for displaying an inside or outside face of the front cover of the electronic print medium upon user selection of the outside edge of the front cover, and
instructions for displaying an inside or outside face of the rear cover of the electronic print medium upon user selection of the outside edge of the rear cover.

3. The computing device of claim 1, wherein each of the at least one graphical effects comprises:
a binding shadow cast on the corresponding page adjacent to a binding between the first page and the second page, and
a page shadow cast by the corresponding group of pages on an area outside of the electronic print medium,
wherein a depth of each binding shadow and a depth of each page shadow is determined based on a depth of pages in the corresponding group.

4. The computing device of claim 1, wherein the machine-readable storage medium further comprises:
instructions for displaying the electronic print medium in a closed position, wherein the closed position shows either an outside face of a front cover or an outside face of a rear cover, and
instructions for displaying a shadow cast by the electronic print medium in the closed position determined based on a length, width, and depth of the electronic print medium.

5. The computing device of claim 1, wherein the instructions for displaying at least one graphical effect implement the adjustment of the shape of the corresponding page in a corresponding group by performing at least one of:
adjusting an amount of empty space in a top and bottom border of the corresponding page,
adjusting an amount of empty space in an inside margin of the corresponding page, and
adjusting a degree of curvature at which the corresponding page meets a binding between the first page and the second page.

6. The computing device of claim 5, wherein:
the amount of empty space in the border and the degree of curvature increase as a depth of the corresponding group increases, and
the amount of empty space in the inside margin decreases as a depth of the corresponding group increases.

7. The computing device of claim 5, wherein a size of an image of content of the corresponding page remains the same during the adjustment of the shape.

8. A machine-readable storage medium encoded with instructions executable by a processor of a computing device, the machine-readable storage medium comprising:
instructions for displaying a first pair of adjacent pages of an electronic print medium, wherein each page in the first pair is displayed on top of a corresponding group of pages;
instructions for displaying, for each respective page in the first pair, at least one graphical effect comprising at least one of a shadow and a shape adjustment of the respective page determined based on a depth of pages in the corresponding group;
instructions for receiving an indication to display a new pair of adjacent pages of the electronic print medium, wherein each page in the new pair is on top of a new corresponding group of pages;
instructions for displaying the new pair of adjacent pages; and
instructions for displaying at least one updated graphical effect for each page of the new pair based on a new depth of pages in each new corresponding group.

9. The machine-readable storage medium of claim 8, wherein the at least one graphical effect is generated using a set of images, each image corresponding to a particular effect.

10. The machine-readable storage medium of claim 9, wherein the instructions for displaying at least one graphical effect and the instructions for displaying at least one updated graphical effect comprise:
instructions for performing at least one of scaling, shifting, and flipping each image in the set based on a length or width of the electronic print medium and the depth of pages in the corresponding group; and
instructions for displaying each image in the user interface at a determined location.

11. The machine-readable storage medium of claim 9, further comprising:
instructions for caching each image in the set; and
instructions for generating the at least one graphical effect by performing one or more operations on each cached image.

12. The machine-readable storage medium of claim 9, further comprising:
instructions for displaying a plurality of selectable elements in the user interface, each element corresponding to a viewing size of the electronic print medium,
wherein each viewing size uses a different set of images for generation of the at least one graphical effect.

13. The machine-readable storage medium of claim 9, further comprising:
instructions for displaying a plurality of selectable elements in the user interface, each element corresponding to a viewing size of the electronic print medium,
wherein graphical effects for at least one of the viewing sizes are generated using the set of images for a larger viewing size.

14. The machine-readable storage medium of claim 8, further comprising:
instructions for determining whether an update is required for each of the at least one graphical effect upon receipt of the indication as a condition to executing the instructions for displaying the at least one updated graphical effect.

15. A method for displaying a user interface to a user of a computing device, the method comprising:
receiving, in the computing device, data for a current pair of adjacent pages of an electronic print medium, wherein each page in the pair belongs to a corresponding group of pages;
determining a graphical effect for each respective page of the pair based on a depth of pages in the corresponding group, wherein each graphical effect comprises at least one of a shadow cast by the corresponding group of pages and a shape adjustment for the respective page;
displaying the pair of adjacent pages of the electronic print medium using the received data; and
displaying the graphical effect determined for each page of the pair of adjacent pages.

16. The method of claim 15, wherein:
the step of receiving data for the current pair comprises receipt of data for each page from a remote server, and
the method further comprises prefetching, from the remote server, data for at least one page predicted to be viewed next.

17. The method of claim 16, wherein a number of pages for which data is prefetched is determined based on at least one of a measurement of bandwidth currently available to the user of the computing device and a measurement of a current load on the remote server.

18. The method of claim 16, wherein a number of pages for which data is prefetched is determined based on an interface element setting selected by the user, the interface element setting specifying an amount of bandwidth to be used by the computing device in prefetching data.

19. The method of claim 15, further comprising:
receiving an image of a front cover of the electronic print medium upon initialization of the user interface;
determining a shadow cast by the electronic print medium based on a length and width of the front cover and a depth of the electronic print medium; and
displaying the front cover and the shadow cast by the electronic print medium.

20. The method of claim 15, further comprising:
displaying an interface element allowing the user to select a portion of the electronic print medium to be downloaded to the computing device; and
downloading, from a remote server, the portion of the electronic print medium selected by the user using the interface element.
